(19) United States
(12) Patent Application Publication
(10) Pub. No.: US 2012/0070810 A1
(43) Pub. Date: Mar. 22, 2012

(54) COMPUTER-BASED LANGUAGE TEACHING AID AND METHOD

(76) Inventor: Laura Marie Kasbar, Spokane, WA (US)

(21) Appl. No.: 13/114,618

(22) Filed: May 24, 2011

Related U.S. Application Data
(60) Provisional application No. 61/349,413, filed on May 28, 2010.

(51) Int. Cl. G09B 19/04

(52) U.S. Cl. 434/185

(57) ABSTRACT

Disclosed is a computer-based aid for teaching language for children with speech disorders. The teaching aid comprises a plurality of categorized, discrete multimedia files, each of which comprises discrete synchronized audio and video content pertaining to a subject matter, and a means for aggregating two or more discrete multimedia files into a single aggregated multimedia file comprising aggregated synchronized audio and video content comprising an aggregation of the individual discrete content of the of the two or more discrete multimedia files. The aggregated content is to be learnt by a learner.

### CROSS-REFERENCE TO RELATED APPLICATION

This application claims benefit of priority of U.S. Provisional Patent Application Ser. No. 61/349,413, filed 28 May, 2010, entitled “DISCRETE VIDEO MODELING SYSTEM AND METHOD”, owned by the assignee of the present application and herein incorporated by reference in its entirety.

### BACKGROUND OF THE INVENTION

1. Field of the Invention

The present invention relates to computer-based teaching applications, and more particularly to the computer-based teaching applications intended for children, and especially for those with speech disorders.

2. Background Art

Studies conducted recently reveal that globally around one child in every hundred children is diagnosed with neural disorders such as autism, dyslexia, ADHD and so on. Children with these disorders suffer from impairments in social interaction, impairments in communication, learning disabilities, and so on. Simply put, children with these disorders do not develop ample natural speech to meet their daily communication needs. In addition to the speech problems, they also lack social support, meaningful relationships, future employment opportunities, or self-determination. Typically, these children, apart from being administered prescribed medication, are subjected to speech and language therapies in a hope to improve their intellectual performance, and thereby the quality of their lives. Various visual and aural aids are employed by therapists during the course of such therapies.

### SUMMARY OF THE INVENTION

The present invention is one such aid. More particularly, the present invention is a computer-based language teaching aid designed for use by therapists, parents, and so on, for children suffering from any of the disorders that cause speech and language impairment. The teaching aid is a web-based aid comprising a database comprising a plurality of categorized, discrete video clips, each pertaining to a single word that is to be taught. The teaching aid employs a means for aggregating select discrete video clips into a single aggregated video clip wherein, the output of the aggregated video clip is rendered in an embedded multimedia player.

It is an object of the present invention to aid parents, teachers and therapists in conducting speech therapy sessions for learners comprising children comprising students and patients with speech disorders.

It is another object of the present invention to provide a computer-based language teaching aid wherein, teaching sessions can be custom configured as per the discretion of the parents, teachers, and therapists.

It is yet another object of the present invention is to provide such a computer-based language teaching aid that can be accessed via the Internet.

Other objects of the embodiments herein will become readily apparent from the following detailed description taken in conjunction with the accompanying drawings.

### BRIEF DESCRIPTION OF THE DRAWINGS

FIG. 1 is a screenshot of the first facial shot of a model in accordance with the present invention.

FIG. 2 is a screenshot of the second shot comprising a cropped version of facial video shot of FIG. 1 focusing on the model's mouth in accordance with the present invention.

FIG. 3 is a screenshot of the third shot comprising one of the various generalized manifestations of a word according to the present invention.

FIG. 4 is a screenshot showing an exemplary list of discrete multimedia files that are to be selected according to the present invention.

FIG. 5 is a screenshot showing various tabulated “preselected sessions” according to the present invention.

FIG. 6 is a flowchart depicting the method of the present invention.

### FIGURES—REFERENCE NUMERALS

10 . . . Screenshot of the First Shot
12 . . . Model
14 . . . Flashcard
16 . . . Screenshot of the Second Shot
18 . . . Screenshot of the Third Shot

### PARTICULAR ADVANTAGES OF THE INVENTION

Customization and Personalization: The teaching aid of the present invention enables the users thereof to custom configure teaching sessions by selecting and aggregating two or more discrete video clips from a database of a plurality of discrete video clips, wherein the content of each discrete video clips pertains to a single word. The teaching aid can also be personalized for every individual learner. For example, the teaching aid allows discrete video clips that teach words such as “mom,” “dad,” “home,” and so on, to feature a learner's actual family members therein for better grasp of the learner.

Exclusive Design: Another advantage is that the teaching aid of the present invention is especially designed for children with impairments in social interaction, impairments in communication, learning disabilities, and so on. This design is reflected in every aspect of the present invention. For example, one of the shots in every video clip focuses on the mouth of a model as he/she articulates a word that is being taught. This particular shot is incorporated by keeping in mind that children with the aforesaid impairments and disabilities, focus especially on the mouth as they converse with people.

Ready Access: The teaching aid of the present invention is web-based and therefore can be accessed anytime anywhere via a website. This is yet another advantage of the present invention.

Other advantages of the present invention herein will become readily apparent from the following detailed description taken in conjunction with the accompanying drawings.

### DETAILED DESCRIPTION OF A PREFERRED EMBODIMENT

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The present invention comprises a computer-based language teaching aid designed for learners comprising children comprising students and patients as a part of their speech therapy. The teaching aid is designed to be operated by users comprising therapists, parents, and teachers. The teaching aid can is a web-based computer application, and therefore can be accessed from a website via various web browsers known in the art. The teaching aid comprises a database at its backend comprising a plurality of linear, discrete multimedia files divided by a plurality of vocabulary categories such as “alphabet,” “animals,” “body parts,” “furniture,” “social situations,” and so on. Each of the discrete multimedia files can be previewed in a multimedia player embedded into the website.

The output rendered by each discrete multimedia file comprises discrete synchronized audio and video content. Simply put, each discrete multimedia file is a video clip. The discrete content of each discrete multimedia file pertains to a subject matter comprising a single word or a concept that is to be taught. The duration of the discrete multimedia files range from ten seconds to two minutes depending on the words the discrete multimedia files aim to teach. The discrete content of each discrete multimedia file comprises an aggregation of a plurality of shots comprising first, second, and third shots.

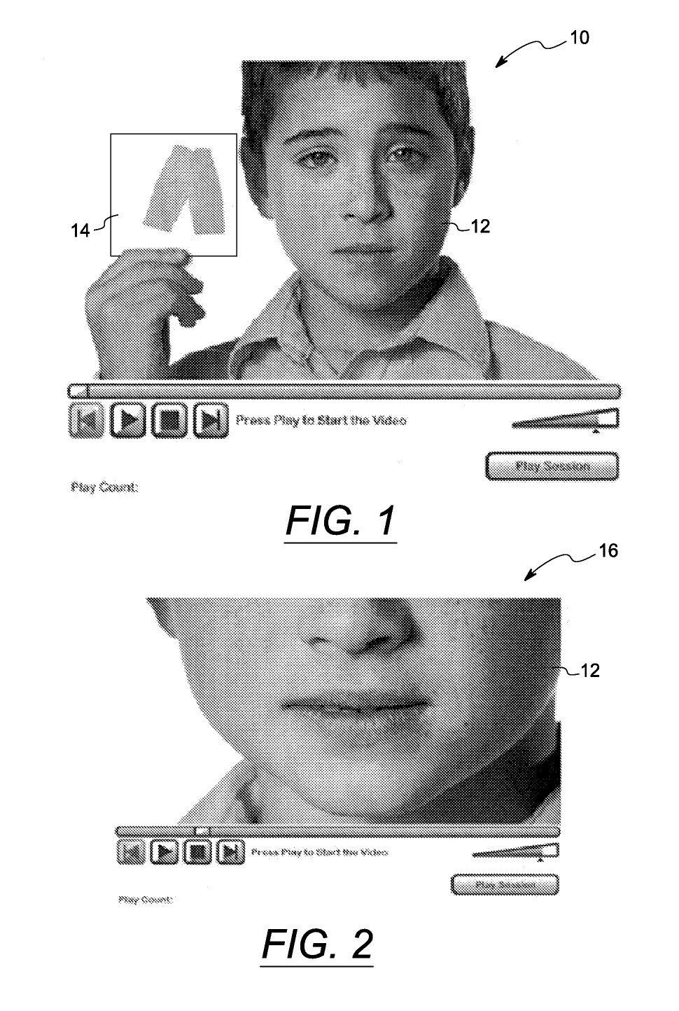

The first shot, a screenshot of which is shown in FIG. 1, comprises a facial shot 10 of a model 12 articulating the word pertaining to the discrete content of the discrete multimedia file. In this shot 10, as can be seen in FIG. 1, the model 12 may hold a flashcard 14 showing the image of a manifestation or materialization of the word while articulating the same. For example, if the word a discrete multimedia file teaches is “pants,” then an image of pants is shown on the flashcard 14 while the word “pants” is being articulated by the model 12. This would help tying the word “pants” to the image on the flashcard 14 in the learner's mind as he/she watches the video as a part of a teaching session. The model 12 is preferably a child as it has been observed that a child model 12, as compared to adult models, can induce a more interest into the learner, who also is around the same age as the child model 12.

A second shot 16, a screenshot of which is shown in FIG. 2, would be a cropped version of the earlier facial shot 10 of the model 12. More particularly, this shot 16 focuses on the mouth of the model 12 as the word is being articulated. The reason for the incorporation of this particular shot 16 is based on an observation that the children with communication impairments tend to focus on the people's mouths as they converse with them. And, through testing it has been found that a video shot comprising a close-up of the mouth is particularly a potent learning incentive for children with speech disabilities, and the like.

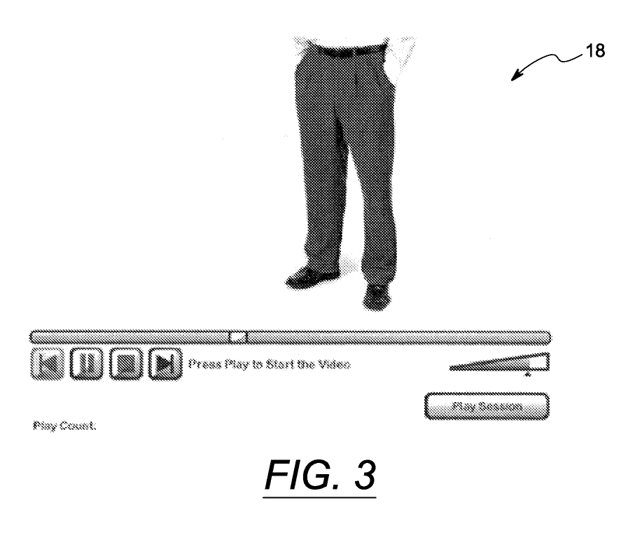

A third shot 18 would be a single or multiple shots displaying various generalized manifestations of the word. For example, referring to the previous “pants”—example, the third video shot 18 would be a single or multiple shots of various pairs of pants of different colors, sizes, and so on. A screenshot of one of the various generalized manifestations of “pants” is shown in FIG. 3. It is to be noted that the generalized manifestations of the word shown in the third shot should be different from that of word shown earlier on the flashcard 14 in the first shot 10 (FIG. 1). This would help guide the learner to a generalized understanding of the word.

Although, the first, second, and third shots are preferably rendered in that order, any order can be adopted nonetheless. All the shots are repeated in the discrete multimedia file so as to improve the learner's retention of the word. Preferably, no objects are placed in the background in the video of the discrete multimedia files as they may cause distractions to the learners. Solid or white colored backgrounds are preferably used. In case of teaching relatively complex words, especially verbs, such as “laughing”, “sleeping”, and so on, a shot comprising the full body of the model 12 performing the act is shown.

In one embodiment of the invention, the discrete content of the discrete multimedia files pertaining to words like “mom/mother”, “dad/father”, “home”, feature the learner's actual mother, father, and home respectively therein. This is made possible by allowing the users to upload relevant, personal videos and/or images into a multimedia template provided by the teaching aid. The words “mom/mother”, “dad/father”, “home”, and so on, are categorized under “family,” “home,” and the like.

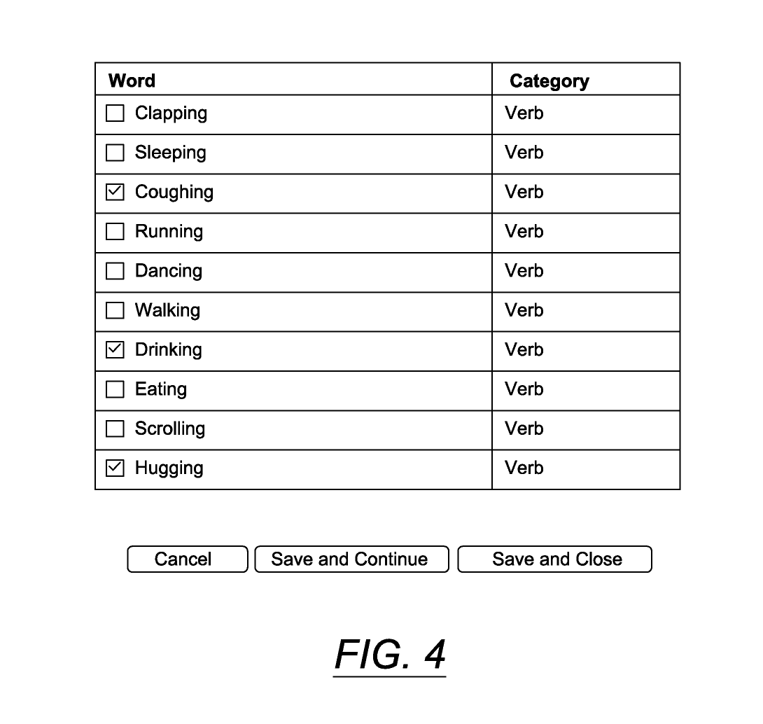

The teaching aid further comprises a “create a custom teaching session” section where users can browse through the categories of discrete multimedia files, preview them, and select a plurality of them they deem fit for the learners. The selection is made by checking each desired discrete multimedia file as seen in FIG. 4, or by dragging-and-dropping desired discrete multimedia files into a selection list, or by any other method known in the art. Once the discrete multimedia files are selected, the user is directed to another section where he/she is prompted to arrange the selected discrete multimedia files in a desired sequential order. Upon confirmation of the sequence, the user is prompted to enter the title of the “custom teaching session” that is about to be made. In one embodiment, the title is to be entered before selection of the discrete multimedia files. In another embodiment, the tile can be entered upon obtaining the aggregated multimedia file. Once the title is inputted, the selected discrete multimedia files are aggregated or merged together so as to form a single aggregated multimedia file or a “custom teaching session.” This way, a user can create numerous aggregated multimedia files or “teaching sessions” of varying lengths as he/she deems fit.

The aggregated multimedia file comprises aggregated synchronized audio and video content, which is an aggregation of the discrete content of the individual discrete multimedia files that are selected. The teaching aid is configured such that the aggregated content is rendered in a seamless manner in an embedded multimedia player as the aggregated multimedia file is executed. The aggregated multimedia files can be stored within the database for future usages. In one embodiment, the detailed break-up of every aggregated multimedia file is shown in a tabulated form. The break-up, for example, includes the duration of aggregated multimedia files, the number of discrete multimedia files each aggregated multimedia file contains, the categories from which the discrete multimedia files are selected, and so on.

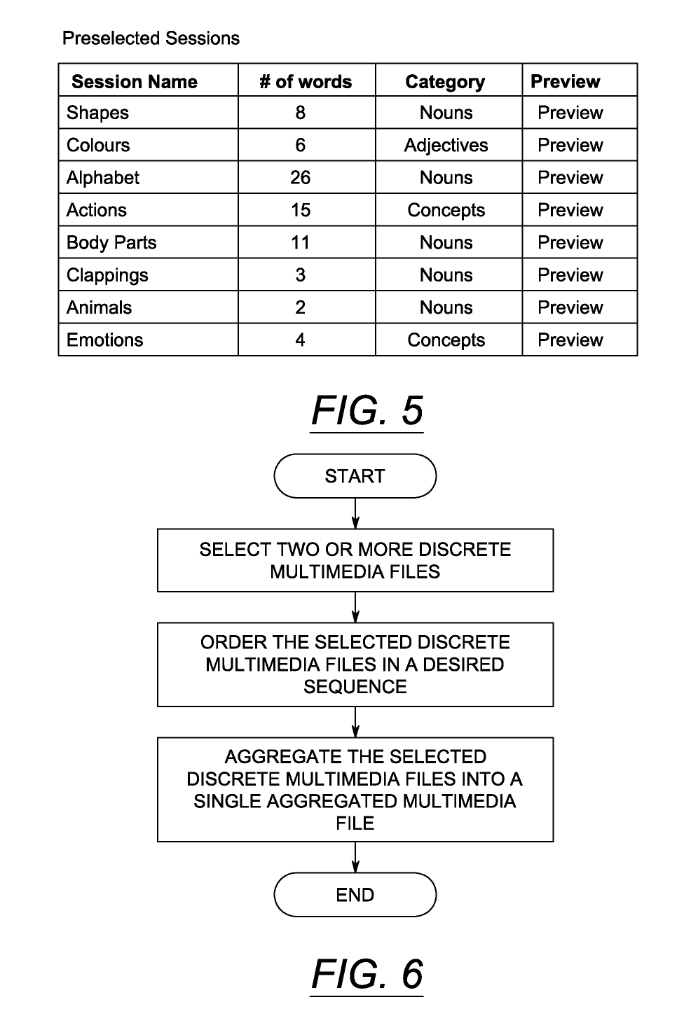

Referring to FIG. 5, in one embodiment of the teaching aid, the database comprises pre-aggregated multimedia files, each comprising an aggregation of preselected discrete multimedia files. The pre-aggregated multimedia files are listed under “preselected sessions” as seen in the referred figure. The duration of each pre-aggregated multimedia file, the category of each pre-aggregated multimedia file, are tabulated as seen in the figure. The teaching aid is configured such that an aggregated or a pre-aggregated multimedia file can be stopped or paused at any point during its ‘play,’ and can be resumed at the same point in the future so as to continue with the same teaching session.

Upon completion of the execution of an aggregated or a pre-aggregated multimedia file, or in other words, upon the completion of a teaching session, a test session commences which tests the degree of retention of the learner. A test session might display shots of various manifestations of the words that are taught in the just-concluded teaching session where, a learner is required to identify the words corresponding to each shot. The teaching aid further comprises a log section where, the date and time details of every activity, the number of times an aggregated or pre-aggregated multimedia file or files are viewed, the test score for each test session, and so on are recorded for future reference. In one embodiment, the teaching aid is configured such that an aggregated or pre-aggregated multimedia file commences upon the obtaining a predetermined score in test session pertaining to a previous video session.

In one embodiment, a social networking module is embedded into the teaching aid so as to facilitate interaction between the fellow users. More particularly, in one embodiment, the teaching aid may notify the users of other parents, teachers, or therapists using the teaching aid residing within the same geographical area as the users. In one embodiment, the teaching aid comprises a medication and dietary section wherein data about the medication and dietary intake of the learners can be inputted. The thus entered dietary intake and medication data can be correlated against respective test scores to see if there is any development in the intellectual performance of the learners. This helps users detect trends or patterns in the learner's intellectual performance relative to the variables in the medication and dietary section.

Referring to FIG. 6, the method of the present invention is initiated by a user selecting two or more discrete multimedia files from a database comprising a plurality of discrete multimedia files, each comprising discrete synchronized audio and video content pertaining to a single word or a concept. Upon selection, the selected discrete multimedia files are set in a sequential order after which, the ordered files are aggregated to form a single aggregated multimedia file comprising aggregated synchronized audio and video content, which is an aggregation of the discrete content of the individual discrete multimedia files that are selected for aggregation. The teaching aid is configured such that the aggregated content is rendered in a seamless fashion.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A computer-based language teaching aid comprising a plurality of categorized, discrete multimedia files, each of which comprises discrete synchronized audio and video content pertaining to a subject matter, and a means for aggregating two or more discrete multimedia files into a single aggregated multimedia file comprising aggregated synchronized audio and video content comprising an aggregation of the individual discrete content of the of the two or more discrete multimedia files; the aggregated content to be learnt by a learner.

2. The aid of claim 1 wherein, the aggregated content is rendered in a seamless manner.

3. The aid of claim 1 wherein, the aggregated content is rendered in an embedded multimedia player.

4. The aid of claim 1 wherein, each discrete multimedia file is previewable.

5. The aid of claim 1 wherein, the subject matter comprises a word.

6. The aid of claim 1 wherein, the discrete content of each discrete multimedia file comprises an aggregation of a plurality of shots comprising:
(a) a first shot comprising a facial shot of a model articulating the subject matter pertaining to the discrete multimedia file;
(b) a second shot comprising a cropped version of the first shot focusing on the model's mouth as the subject matter is articulated; and
(c) a third shot comprising an aggregation of a plurality of shots of different manifestations of the subject matter.

7. The aid of claim 6 wherein, each discrete multimedia file is configured such that at least one of the first, second, and third shots are repeated.

8. The aid of claim 1 comprising a web-based application.

9. The aid of claim 1 further comprising pre-aggregated multimedia files wherein, each pre-aggregated multimedia file comprises an aggregation of two or more discrete multimedia files preselected from the plurality of discrete multimedia files.

10. The aid of claim 1 further comprising personalized, discrete multimedia files, each of which comprises personalized discrete synchronized audio and video content featuring the learner's actual family members therein.

11. A computer-implemented method for use in teaching comprising selecting two or more discrete multimedia files from a database comprising a plurality of categorized, discrete multimedia files, each of which comprises discrete synchronized audio and video content pertaining to a subject matter, and aggregating two or more discrete multimedia files into a single aggregated multimedia file comprising aggregated synchronized audio and video content comprising an aggregation of individual discrete content of the two or more discrete multimedia files; the aggregated content to be learnt by a learner.

12. The method of claim 11 wherein, the aggregated content is rendered in a seamless manner.

13. The method of claim 11 wherein, the aggregated content is rendered in an embedded multimedia player.

14. The method of claim 11 wherein, each discrete multimedia file is previewable.

15. The method of claim 11 wherein, the subject matter comprises a word.

16. The method of claim 11 wherein, the discrete content of each discrete multimedia file comprises an aggregation of a plurality of shots comprising:
(a) a first shot comprising a facial shot of a model articulating the subject matter the discrete multimedia file pertains to;
(b) a second shot comprising a cropped version of the first shot focusing on the model's mouth as the subject matter is articulated; and
(c) a third shot comprising an aggregation of a plurality of shots of various manifestations of the subject matter.

17. The method of claim 16 wherein, each discrete multimedia file is configured such that at least one of the first, second, and third shots are repeated.

18. The method of claim 11 being web-based.

19. The method of claim 11 wherein, the database further comprises personalized, discrete multimedia files, each of which comprises personalized discrete synchronized audio and video content featuring the learner's actual family members.

20. The method of claim 11 wherein, the database comprises pre-aggregated multimedia files wherein, each pre-aggregated multimedia file comprises an aggregation of two or more discrete multimedia files preselected from the plurality of discrete multimedia files.

21. A computer-based aid for teaching language comprising:
(a) a database comprising a plurality of categorized, previewable, linear, discrete multimedia files, each comprising discrete synchronized audio and video content pertaining to a subject matter, the discrete content of each discrete multimedia file comprising an aggregation of a plurality of shots comprising:
(i) a first shot comprising a facial shot of a model articulating the word the discrete multimedia file pertains to;
(ii) a second shot comprising a cropped version of the first shot focusing on the model's mouth as the word is articulated; and
(iii) a third shot comprising an aggregation of a plurality of shots of various manifestations of the word; and
(b) a means for aggregating selected multimedia files into a single aggregated multimedia file comprising aggregated synchronized audio and video content comprising an aggregation of individual discrete content of the two or more discrete multimedia files;
wherein, the aggregated content is to be learnt by a learner.
